(19) United States
(12) Patent Application Publication
(10) Pub. No.: US 2011/0208475 A1
(43) Pub. Date: Aug. 25, 2011

(54) ABSOLUTE ANGLE CODING AND ANGLE MEASURING DEVICE

(75) Inventor: Christoph Lingk, Traunstein (DE)

(73) Assignee: Dr. Johannes Heidenhain GmbH, Traunreut (DE)

(21) Appl. No.: 13/126,699

(22) PCT Filed: Oct. 1, 2009
(86) PCT No.: PCT/EP09/07041

§ 371 Date: Apr. 28, 2011

(30) Foreign Application Priority Data
Oct. 30, 2008 (DE) 10 2008 053 985.6

(51) Int. Cl. G06F 15/00

(52) U.S. Cl. 702/151

(57) ABSTRACT

An absolute angle coding that includes a first code sequence disposed within 360°, wherein the first code sequence has a first length and is disposed N_{A} times in succession. The absolute angle coding includes a second code sequence disposed within 360°, wherein the second code sequence has a second length and is disposed N_{B} times in succession, wherein the first code sequence and the second code sequence in combination absolutely unambiguously encode said 360°. In addition, N_{A} is greater than or equal to 2 and N_{B} is greater than or equal to 2 and N_{A} is not equal to N_{B}. The first length is not equal to the second length and the first code sequence and the second code sequence are disposed in one common track, in that a part of the first code sequence and a part of the second code sequence are disposed in alternation.

In many fields, absolute angle measuring devices are used to determine the position of two bodies moved relative to one another. Compared to systems that measure purely incrementally, absolute angle measuring devices have the advantage that in every relative position, even after the energy supply has been interrupted, correct position information can be output immediately.

The absolute position is embodied by an angle coding. Disposing the position information in a single code track, with code elements disposed in succession in the measurement direction, is especially space-saving. The code elements are disposed in succession in pseudo-random distribution, so that a certain number of successive code elements each form one code word, which unambiguously defines the absolute position. When the scanning unit is displaced relative to the angle coding by a single code element, a new code word is already formed, and over the entire range (360°) to be detected absolutely, a succession of different code words is available. This kind of serial or sequential code is also often called a chain code or a pseudo-random code (PRC).

For determining the absolute position from the scanned code words—also called decoding—a decoding table is used, in which one position is associated with each code word. For associating the absolute position with a scanned code word, the code word forms the address for the decoding table, so that at the output, the absolute position stored in memory for this code word is present and is available for further processing. These nonvolatile tables can be designed today in hardware-wired fashion in an ASIC, to make fast access possible.

The demands in terms of resolution of angle measuring devices are becoming more and more stringent, so that over 360°, many positions have to be encoded unambiguously. The more positions have to be encoded, the more complex is the ensuing decoding. In serial encoding, it is problematic that for high resolution, a very great number of different code words have to be generated and decoded. If the decoding is done by means of tables, a large table is required, in which for every possible code word, one associated absolute position is stored in memory. If the decoding is done with a computer, the result is relatively long computation times.

U.S. Pat. No. 6,330,522 B1 shows a provision for how an angle coding and an angle measuring device can be designed in order to reduce the complexity of decoding. In it, a first code sequence of a first length and a second code sequence of a second length are disposed over 360°, in tracks extending parallel to one another. The first code sequence is disposed five times over 360°, and the second code sequence is disposed fourteen times over 360°. The bit width of the first code sequence differs from the bit width of the second code sequence. The decoder device has a first value set for decoding the first code sequence and a second value set for decoding the second code sequence. The absolute position is unambiguous because of the combination of the two partial positions at every point over 360°.

A disadvantage of a parallel arrangement of code sequences is on the one hand the vulnerability to moiré shifts in scanning, and the relatively few absolutely codable positions over 360°.

It is therefore the object of the invention to disclose an angle coding with which many positions over 360° can be unambiguously encoded, and with which in an angle measuring device, simple decoding of the successions of code words, generated by scanning this angle coding, is made possible.

This object is attained by the angle coding recited in claim 1.

In claim 12, an absolute angle measuring device with an angle coding of this kind is recited.

The absolute angle coding has a plurality of code sequences disposed within 360°, which in combination absolutely unambiguously encode the 360°. The first code sequence has a first length L_{A} and is disposed N_{A} times in succession, and the second code sequence has a second length L_{B} and is disposed N_{A} times in succession, where

N_{A} is greater than or equal to 2 and is an integer or not an integer;

N_{B} is greater than or equal to 2 and is an integer or not an integer;

N_{A} is not equal to N_{B};

L_{A} and L_{B} are integers

L_{A} is not equal to L_{B};

Furthermore, the first code sequence and the second code sequence are disposed in one common track, in that a part of the first code sequence and a part of the second code sequence are disposed in alternation. In particular, one code element of the first code sequence is followed by a single code element of the second code sequence each time, and a code element of the second code sequence is followed by a single code element of the first code sequence each time.

The code sequences are disposed circularly on a disk or over the circumference of a drum concentrically to the pivot point. A part of the code sequence means that this can be one or more successive code elements of this code sequence. In the exemplary embodiments that follow, this part in each case is a single code element. A code element in each case is a range of the angle coding from which a bit 0 or 1 can be derived.

“Code sequence” means a succession of a plurality of code elements that defines different positions, over the total length of the code sequence, in the grid of a code element.

The term “cyclically continued code sequence” means that at the end of the code sequence, the beginning of this same code sequence ensues again.

The length of a code sequence defines the angle sector that one code sequence includes. Since the code elements of all the code sequences each include identical angle sectors, the length of the code sequence is equal to the number of code elements within the code sequence, and thus to the number of bits that can be derived therefrom.

For generating a shift of the positions of both code sequences, the length of the first code sequence is advantageously not a multiple of the length of the second code sequence. The shifting length of the code sequences is maximal when the length of the first code sequence differs by 1 from the length of the second code sequence, or in other words when one of the two code sequences has one single code element more than the other of the two code sequences.

A first angle coding that is especially simple to decode is obtained if over 360°, the first code sequence is disposed N_{A} times, and the second code sequence is disposed N_{B} times, where N_{A} and N_{B} are both integers.

This angle coding that is especially simple to decode endlessly over the entire circumference (360°) has M₁ different absolute positions over 360°, if the angle coding has a number M₁=2*KGV (L_{A}, L_{B}) code elements are disposed, where

KGV (L_{A}, L_{B}) is the least common multiple of L_{A} and L_{B}

L_{A} is the length of the first code sequence A;

L_{B} is the length of the second code sequence B

For N_{A} the following is then true: N_{A}=KGV (L_{A}, L_{B})/L_{A}.

For N_{B} the following is then true: N_{B}=KGV (L_{A}, L_{B})/L_{B}.

The maximum number of different positions is attainable if L_{A} differs from L_{B} by 1. Then the following is true:

M₁ₘₐₓ=2*L_{A}*L_{B}

The words (bit patterns) obtained in the scanning of this angle coding by means of a detector array can be decoded by means of two value sets available in a decoding device. The first value set is embodied for decoding a first succession of code words, which occurs in each case upon scanning of the first code sequence and its cyclical continuation. The second value set is embodied for decoding a second succession of code words, which occurs each time upon the scanning of the second code sequence and of its cyclical continuation.

The outcome of the decoding of the first succession of code words is a first partial position within the first code sequence, and the outcome of the decoding of the further succession of code words is a second partial position within the second code sequence. The total position value is obtained from the two partial positions.

If over 360°, a number M₂ of absolute positions that differs from M₁=2* KGV (L_{A}, L_{B}) is required, in particular M₂=2^{k} different positions, then in a second angle coding over 360° the number of the code elements is as follows:

M₂<2*KGV (L_{A}, L_{B}), where

KGV (L_{A}, L_{B}) is the least common multiple of L_{A} and L_{B}

L_{A} is the length of the first code sequence A;

L_{B} is the length of the second code sequence B

The first code sequence is disposed N_{A} times, where

N_{A}>2 and N_{A} is not an integer,

so that the first code sequence has a joint, and/or

the second code sequence is disposed N_{B} times, where

N_{B}>2 and N_{B} is not an integer,

so that the second code sequence has a joint.

In other words, in that case at least one of the two code sequences is plotted only partially once within 360°, and the part of this code sequence not plotted is cut out, and the remainder is attached to the next code sequence. At this attachment point, this code sequence is interrupted, since an joint region occurs here, at which in the scanning a new succession of code elements occurs, that is, new bit patterns or words. New bit patterns means that these bit patterns are not a component of the code sequences or their cyclical continuations. The “cutting out” or the “joint” is done at a boundary between two code elements, so that over 360°, a whole number of code elements of all the code sequences is always present.

In this second angle coding, in order to utilize the code sequences well and to enable the highest possible number of positions, the number over 360° is advantageously

M₂=2*(KGV (L_{A}, L_{B})−E*L_{A}), which means that only one of the second code sequences B is incomplete, or

M₂=2*(KGV (L_{A}, L_{B})−E*L_{B}), which means that only one of the first code sequences A is incomplete.

Here, E>0 and is an integer.

The second angle coding now makes it possible to dispose M₂=2^{k} code elements over 360°, where k is preferably less than 4 and an integer.

For decoding the words obtained in the scanning of the second angle coding, a further value set is now required besides the first and second value sets. This further value set is designed for decoding the joint in the cyclical continuation of the first and/or second code sequence, that is, the joint region, and it now contains the bit patterns which occur newly in the scanning of the joint region, or in other words which are not a component of the first or second value set.

Further advantageous features of the invention are recited in the dependent claims.

Exemplary embodiments of the invention will be described in further detail in conjunction with the drawings.

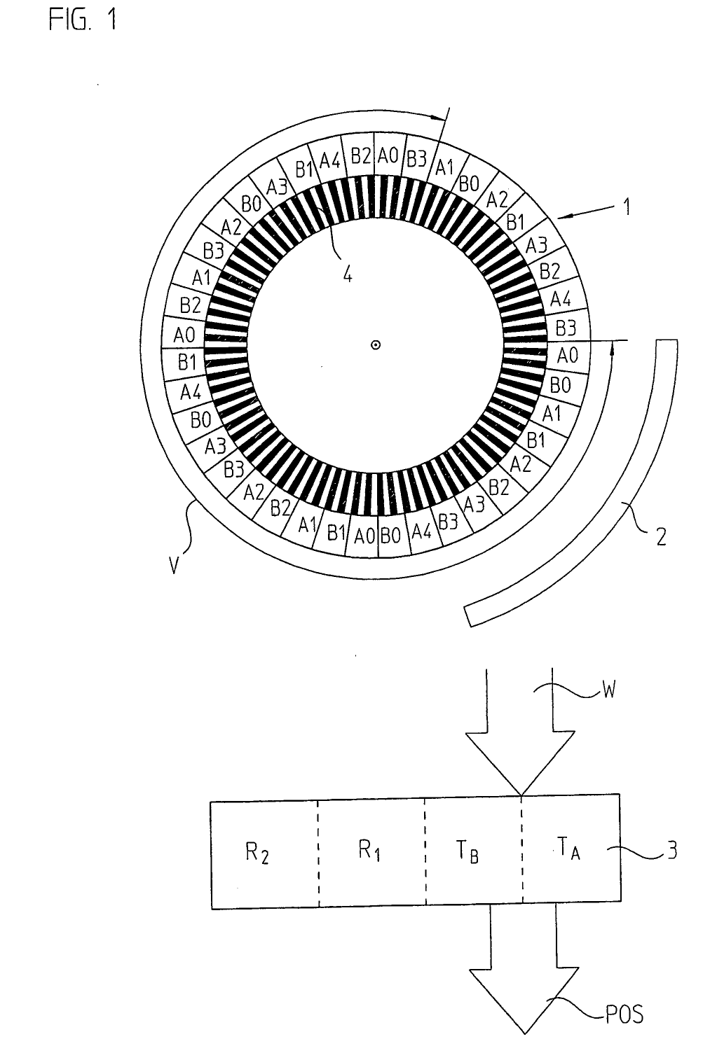

FIG. 1 shows a first angle measuring device with a first angle coding in a schematic illustration;

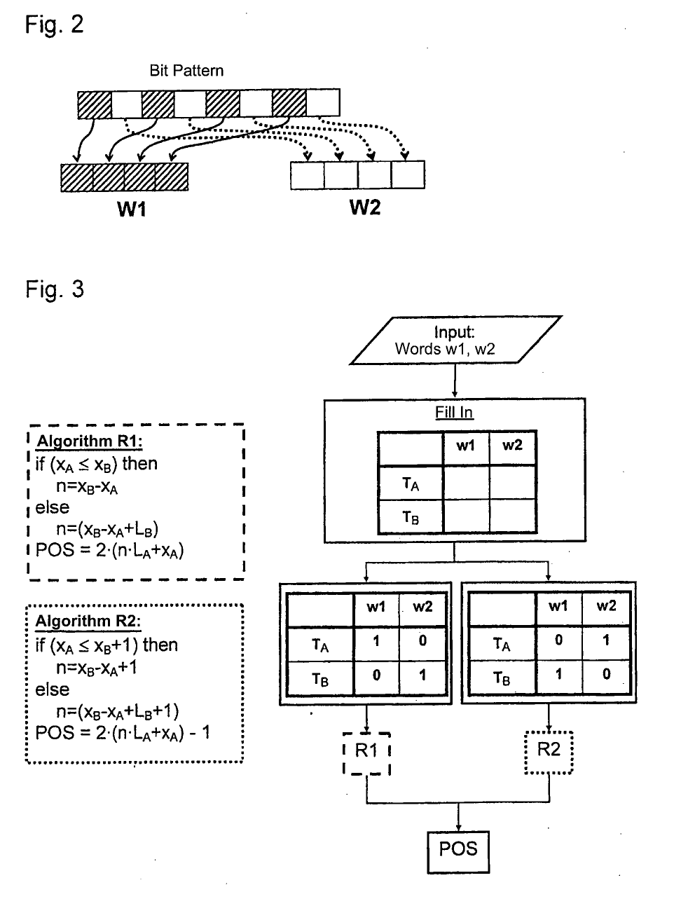

FIG. 2 shows a bit pattern of the detector array of the first angle measuring device;

FIG. 3 is a flow chart with algorithms for ascertaining the position of the first angle measuring device;

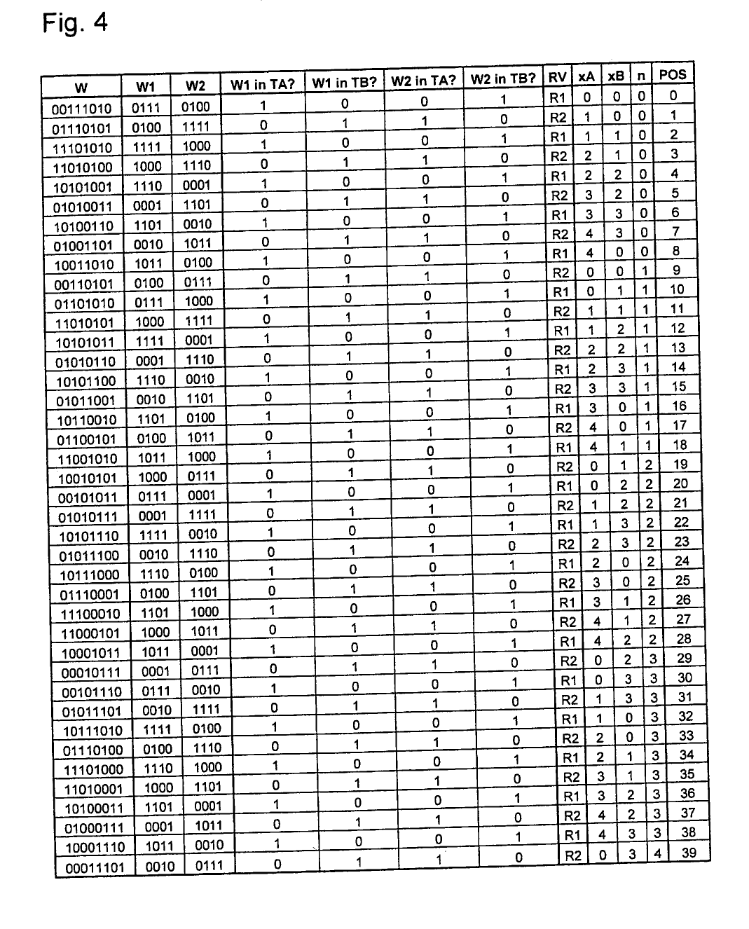

FIG. 4 is a graph showing the position of read-out bit patterns (words) based on an example of the first angle coding;

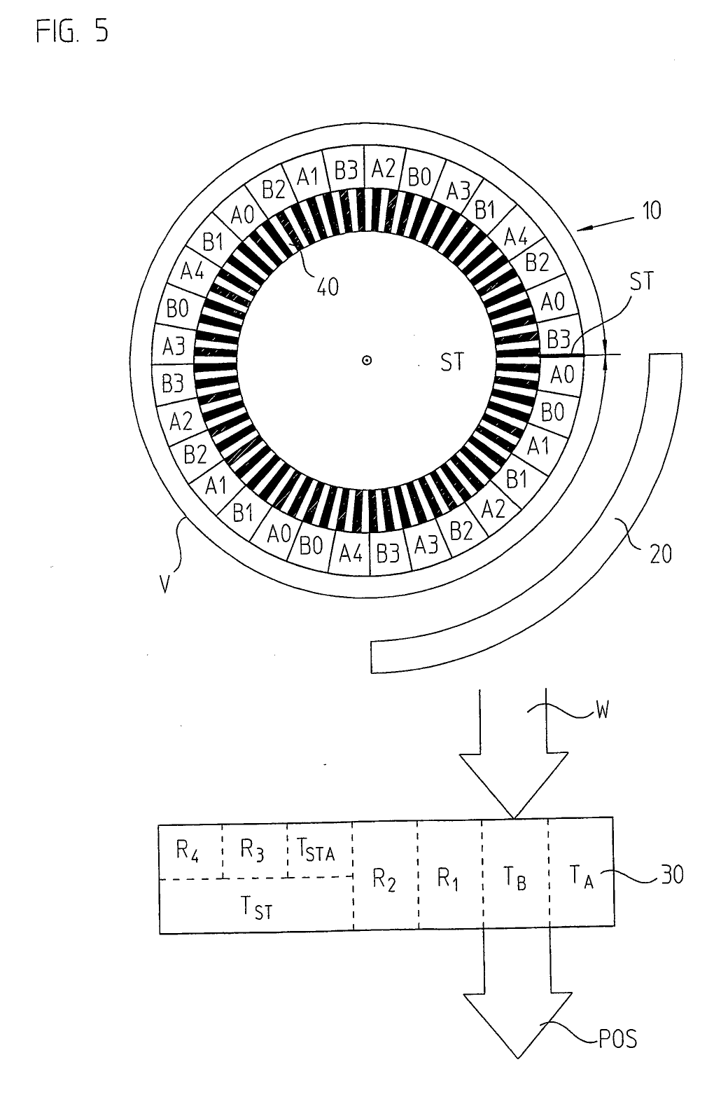

FIG. 5 shows a second angle measuring device with a second angle coding in a schematic illustration;

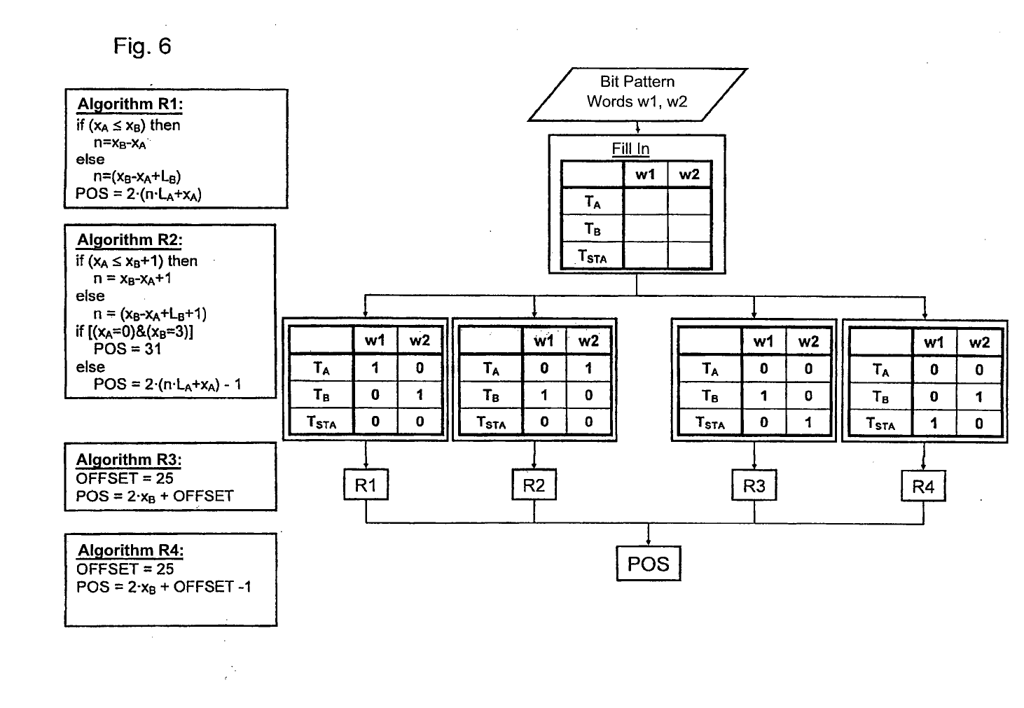

FIG. 6 is a flow chart with algorithms for ascertaining the position of the second angle measuring device; and

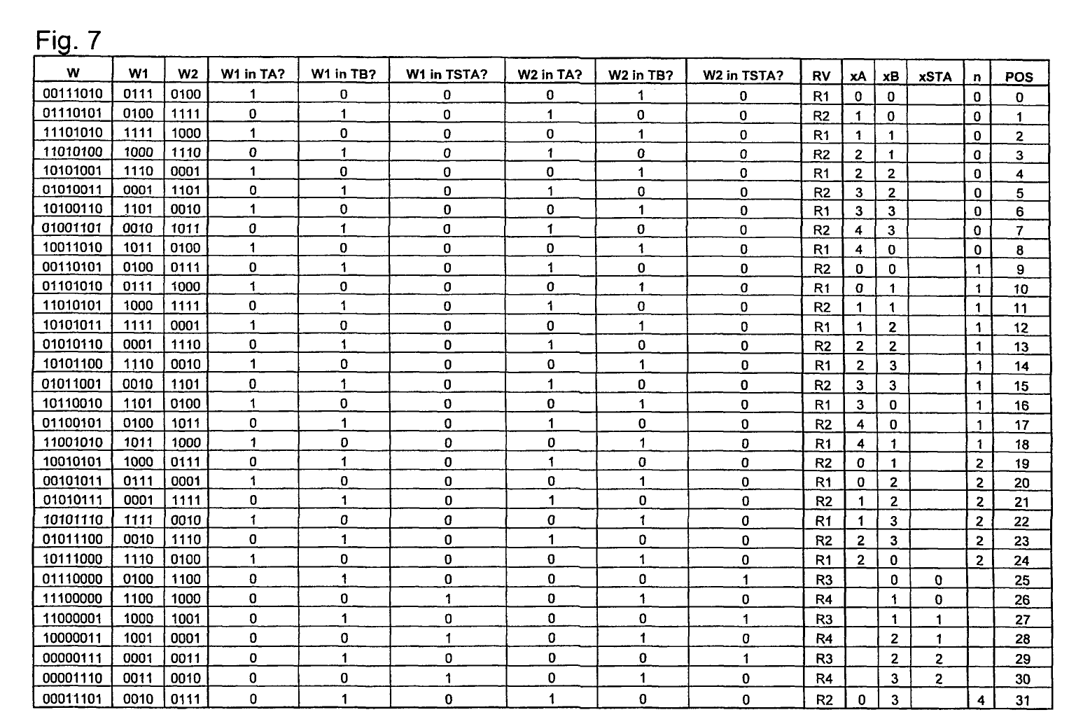

FIG. 7 is a graph showing the position of read-out bit patterns (words) based on an example of the second angle coding.

In the invention, the Nonius principle is employed. For absolute position measurement, two serial code sequences A, B are used, which include different lengths L_{A} and L_{B}. At each position within the measurement range of 360°, the unambiguous absolute position POS is now obtained from the combination of partial positions x_{A}, x_{B} of the plurality of serial code sequences A, B. The advantage of such encoding is that a decoder device 3 has to decode only the relatively short plurality of serial code sequences A, B and their cyclical continuations, and then the unambiguous position POS can be ascertained over 360° by relatively simple relations from these decoded code sequences A, B. If the decoding is done by means of tables, all that is needed is a plurality of small tables. This requires far fewer table entries than there are absolute positions that can be output.

In FIG. 1, a first absolute angle coding 1 and angle measuring device embodied according to the invention are shown schematically. The angle coding 1 is embodied such that within one complete revolution, that is, endlessly over 360°, it defines one unambiguous absolute position POS at every position. To that end, the angle coding 1 comprises a succession, disposed one after the other, of code elements A0 through A4 and B0 through B3, which each include one angle sector of the same size.

The principle of the position measurement is based on the shifting of two code sequences A, B of different lengths L_{A} and L_{B}, where L_{A}, L_{B} are integral and preferably relatively prime. The maximum length to be decoded, M₁ₘₐₓ, is obtained if L_{A} differs from L_{B} by 1.

Let the first code sequence A be defined by the bit sequence

A₀,A₁,A₂,A₃ . . . A_{LA-1} of length L_{A}.

Let the second code sequence B be defined by the bit sequence

B₀,B₁,B₂,B₃ . . . B_{LB-1} of length L_{B}.

Here, Aᵢ, Bᵢ∈{0;1}. The angle coding 1 is then produced by the alternation disposition of one bit from the code sequence A and then one bit from the code sequence B:

$$\vert {}_{{M}_{1 max} = 2 * {L}_{A} * {L}_{B}}^{{A}_{0} {B}_{0} {A}_{1} {B}_{1} {A}_{2} {B}_{2} … {A}_{LA - 1} {B}_{LB - 1}} \vert {A}_{0} {B}_{0 } …$$

Because of the different lengths L_{A}, L_{B} of the code sequence A and the code sequence B, the result is a shift between the code sequences A and B. The total encodable length M₁ₘₐₓ (that is, the length after which the bit pattern repeats) is defined, when L_{A}−L_{B}=1, by

M₁ₘₐₓ=2*KGV (L_{A}, L_{B})=2*L_{A}*L_{B},

where KGV (L_{A}, L_{B})=the least common multiple of L_{A} and L_{B}.

According to the invention, angle codings with code sequences of arbitrary length difference L_{A}−L_{B} are also possible. In the case where L_{A}−L_{B} is not equal to 1, however, the maximum codable length M₁ₘₐₓ is less, and the evaluation algorithm may be more complicated, so that here, only the especially advantageous example in which L_{A} differs from L_{B} by 1 will be described in detail.

For the position measurement, the angle coding 1 is scanned, for instance optically, in that the code elements modulate a beam of light as a function of position, so that at the location of a detector array 2 of a scanning unit, a position-dependent distribution of light occurs that is converted by the detector array 2 into electrical scanning signals w. The detector array 2 is a line sensor, with a succession of detector elements disposed in the measurement direction. The detector elements are embodied such that at least one of the detector elements is unambiguously associated with each of the code elements in each relative position, and thus from each of the code elements, one bit, 0 or 1, can be obtained. To that end, in the case of the optical scanning principle, the code elements are reflective or nonreflective, or opaque or nonopaque, and the reflective code elements are for instance assigned the bit value 1 while the nonflective code elements are assigned the bit value 0. The succession of these bits (bit pattern) within one code sequence A, B, whose number is dependent on the scanning length L_{L}, forms one code word w for each of the two code sequences A, B. The scanning signals, that is, the code words w, are delivered to a decoder device 3, which from each of the code words w of one of the code sequences A, B derives a partial position x_{A}, x_{B}, and from these partial positions x_{A}, x_{B}, then forms an absolute position POS therefrom. When the detector array 2 is displaced relative to the angle coding 1 by the width or length of one code element A, B, one new code word w is generated from each of the code sequences A, B.

For decoding the code words w, the decoding device 3 has two tables T_{A}, T_{B}, that is, table T_{A} for the code sequence A and table T_{B} for the code sequence B. A certain number of code elements is scanned by the detector array 2 to generate the code words w. The number of scanned code elements of the two code sequences A, B is called the scanning length L_{L} and is preferably an even number of code elements or bits. The bit succession (bit pattern) generated by the detector array 2 is decoded into two words w₁ and w₂, as shown in FIG. 2. For the decoding, the two words w₁ and w₂ are searched for in the two tables T_{A}, T_{B} of the decoding device 3:

w₁→T_{A}; w₁→T_{B}; w₂→T_{A}; w₂→T_{B} in order to attain an association:

w₁→w_{A} and w₁→w_{B}, respectively, and w₂→w_{A} and w₂→w_{B}, respectively.

In the search, the following possibilities exist:

| Positions | Decoding |
|---|---|
| Even-numbered positions | X_{A} = T_{A}(w₁) |
| (0, 2, 4 . . . ) | X_{B} = T_{B}(w₂) |
| Odd-numbered positions | X_{A} = T_{A}(w₂) |
| (1, 3, 5 . . . ) | X_{B} = T_{B}(w₁) |

In these:
w₁, w₂ are the words w read by the angle coding 1
x_{A}, x_{B} are partial positions within the code sequences A and B, respectively, and thus within the tables T_{A} and T_{B}, respectively
the decoding is the ascertainment of positions x_{A}, x_{B} from the words w₁, w₂.

In this first exemplary embodiment, the two code sequences A, B are each disposed N_{A} and N_{B} times, respectively, within 360°, and N_{A} and N_{B} are integers. Each code sequence A, B is adjoined by the beginning of the same code sequence A, B again, so that at each seam of successive code sequences A, B, this code sequence A, B is cyclically continued.

The flow chart shown in FIG. 3 and the algorithms given for it describe the calculation of the total position POS from the positions x_{A}, x_{B}. As FIG. 1 schematically shows, the algorithms R1, R2 in the decoding device 3 are implemented in order to ascertain the total position POS by means of the partial positions x_{A}, x_{B} obtained from the tables T_{A} and T_{B}, respectively.

With the angle coding 1 shown as an example in FIG. 1, the results are thus as follows:

length of the code sequence A: L_{A}=5

code sequence A: A₀A₁A₂A₃A₄

length of the code sequence B: L_{B}=4

code sequence B: B₀B₁B₂B₃

scanning length: L_{L}=8

M₁ₘₐₓ=2*L_{A}*L_{B}=40

KGV (L_{A}, L_{B})=20

N_{A}=KGV (L_{A}, L_{B})/L_{A}=4

N_{B}=KGV (L_{A}, L_{B})/L_{B}=5

The table T_{A} for code sequence A:

| Bit Pattern | Word w | Partial Position x_{A} |
|---|---|---|
| A₀A₁A₂A₃ | W_{A0} | 0 |
| A₁A₂A₃A₄ | W_{A1} | 1 |
| A₂A₃A₄A₀ | W_{A2} | 2 |
| A₃A₄A₀A₁ | W_{A3} | 3 |
| A₄A₀A₁A₂ | W_{A4} | 4 |

The table T_{B} for code sequence B:

| Bit Pattern | Word w | Partial Position x_{B} |
|---|---|---|
| B₀B₁B₂B₃ | W_{B0} | 0 |
| B₁B₂B₃B₀ | W_{B1} | 1 |
| B₂B₃B₀B₁ | W_{B2} | 2 |
| B₃B₀B₁B₂ | W_{B3} | 3 |

These two tables T_{A}, T_{B} together contain 9 entries, and with these 9 entries, 40 different positions can be decoded unambiguously, specifically over 360° in angular steps corresponding to the width of one code element. The prerequisite for such decoding is that each of the two code sequences A, B is disposed in complete form multiple times over 360°; that is, at the end of one code sequence A, B, that code sequence A, B begins again and is disposed completely until the beginning of the next code sequence A, B.

In FIG. 4, a graph is shown for ascertaining the position POS from read-out bit patterns (words) w based on the example of the first angle coding 1. In the second and third columns, the words w1 and w2 ascertained from the words w of FIG. 2 are shown. The five further columns show the question of whether the words w1 or w2 have been found in the tables T_{A} or T_{B}. A “1” defines “found”. The next column marked “RV” defines the algorithm R1 or R2 to be used. In the following two columns, the partial positions x_{A} and x_{B} are given. The next column contains the value “n” calculated by the rules given in FIG. 3. The last column now contains the position POS calculated in accordance with the corresponding algorithms R1 and R2.

If the position measurement value ascertained from the two code sequences A, B is to be resolved further, then the above-described angle coding 1 can be expanded by one further track or a plurality of further tracks with absolute codes or with incremental graduations.

It can also be advantageous, from the absolute angle coding 1, additionally to derive a periodic incremental signal.

One example of an advantageous arrangement of an additional incremental track 4 is shown in FIG. 1. An incremental track 4 is provided parallel, that is, concentrically, to the track having the code sequences A, B. The graduation period of this incremental track 4 is for instance a fraction of the width of one code element of the code sequences A, B, and the boundaries of the code elements are aligned with boundaries of the graduation period of the incremental track 4. Within one angle sector of one code element, a whole number, advantageously greater than 1, of incremental graduation periods is advantageously disposed. This dimensioning of the incremental track 4 makes it possible to further subdivide the width of one code element. To that end, the incremental graduation 4 is scanned by means of a further detector unit, not shown, which in a known manner generates a plurality of incremental signals phase-offset from one another. These incremental signals are delivered to an interpolator, which further subdivides the incremental signals and outputs an absolute partial position within the width of one code element. The absolute position POS obtained from the absolute angle coding 1 and the partial position obtained from the incremental track 4 are delivered to a combination unit, which from them forms a total position, which over the measurement range of 360° is absolute and thus unambiguous and has a resolution corresponding to the interpolation step ascertained from the incremental graduation.

For many applications, however, an angle coding is now wanted which defines M₂=2^{k} different positions over one revolution, that is, within 360°. Below, in conjunction with FIGS. 5 through 7, a second exemplary embodiment of the invention will now be described, in which for forming an angle coding 10, at least one of the code sequences A, B within the 360° is therefore embodied incompletely once, in order to define the desired M₂=2^{k} different positions. Once again, the angle coding 10 is defined by the lengths L_{A} and L_{B} of the code sequences A and B, and L_{A} is not equal to L_{B}, and L_{A} and L_{B} are integers. It is thus not possible to select L_{A} and L_{B} such that M₂=2*KGV (L_{A}, L_{B})=2^{k}, where k>0 and an integer. To achieve that, from the angle coding 1 of the maximum length M₁ₘₐₓ described for the first example, only one range V of the length M₂=2^{k} is now adopted.

Let there now also be a detector array 20 with a scanning length L_{L}, with L_{L} being an even number. For this system, there are now two ranges:

First Range: Positions 0 . . . to (M₂-L_{L}):

This is the range in which for the angle coding 10, the range V adopted from the angle coding 1 is present, and in which the total position POS can be calculated by means of the algorithms R₁ and R₂ of the first exemplary embodiment.

Second Range: Positions (M₂-L_{L}+1) . . . to(M₂-1):

By joining together the range V taken over, a new joint ST is obtained, at which at least one of the code sequences A, B and the cyclical continuation of at least one of the code sequences (in this case the code sequence A) is interrupted. This range over this joint ST dictates special treatment with at least one additional value set for decoding bit patterns, that is, a special table, since the bit patterns generated in the scanning over this joint ST are not present in the tables T_{A} and/or T_{B}.

Further explanations will be made below in terms of one example:

Number of bits required per circumference: M₂=32=2⁵

Scanning length: L_{L}=8

L_{A}=5

L_{B}=4

The full angle coding 1 has a length=2*L_{A}*L_{B}=40 positions, and to create the requisite angle coding 10 it is cut off or reduced to a length M₂ of 32 positions. In FIGS. 1 and 5, this reduced range is marked V.

The code sequences A and B are defined by the following:

Code sequence A: A₀A₁A₂A₃A₄

Code sequence B: B₀B₁B₂B₃

The tables T_{A} and T_{B} are then defined as follows:

TABLE T_{A}
For code sequence A

| Bit Pattern | Word w | Partial Position x_{A} |
|---|---|---|
| A₀A₁A₂A₃ | W_{A0} | 0 |
| A₁A₂A₃A₄ | W_{A1} | 1 |
| A₂A₃A₄A₀ | W_{A2} | 2 |
| A₃A₄A₀A₁ | W_{A3} | 3 |
| A₄A₀A₁A₂ | W_{A4} | 4 |

TABLE T_{B}
For code sequence B

| Bit Pattern | Word w | Partial Position x_{B} |
|---|---|---|
| B₀B₁B₂B₃ | W_{B0} | 0 |
| B₁B₂B₃B₀ | W_{B1} | 1 |
| B₂B₃B₀B₁ | W_{B2} | 2 |
| B₃B₀B₁B₂ | W_{B3} | 3 |

Now, what happens to the code sequences A and B at the new joint ST?

First, one can see that the code sequence B was cut off precisely at its cyclical continuation (that is, between B₃ and B₀). Thus if the detector array 20 moves past the joint ST, no problems arise with the code sequence B (“B grid”) and with the table T_{B}: the bit B₃ is followed again by the bit B₀. The code sequence B and its cyclical continuation are accordingly not interrupted.

Conversely, the code sequence A is interrupted at the joint ST. For the code sequence A, as the detector array 20 passes over the joint ST, new bit patterns now occur, which do not occur in the table T_{A}. The bit A₀ is in fact not followed by A₁ but rather by A₀ again and only then by A₁. The new positions of the code sequence A at the joint ST can be summarized in a new table T_{STA} (“ST” stands for joint; “A” stands for code sequence A).

TABLE T_{STA}

| Bit Pattern | Word w | Partial Position x_{STA} |
|---|---|---|
| A₃A₄A₀A₀ | W_{STA0} | 0 |
| A₄A₀A₀A₁ | W_{STA1} | 1 |
| A₀A₀A₁A₂ | W_{STA2} | 2 |

POS_{ST} can now be ascertained by means of the tables T_{B} and T_{STA}. The associated algorithms R3 and R4 are shown in FIG. 6. It should be noted that these algorithms R3 and R4 are given only as examples, since still other relations may be used instead. The algorithms R1 and R2 correspond to the algorithms R1 and R2 of the first exemplary embodiment (FIG. 3), with the special treatment for the position 31.

Another possibility for ascertaining the positions POS_{ST} at the joint ST is to look at the successive bit patterns in their entirety and not to divide them at the joint ST into the two code sequences A and B. To that end, the (L_{L}-1)=7 bit patterns of the joint ST are written into a table T_{ST}, in which the word length in this table T_{ST} is now L_{L}, or in the example, 8.

TABLE T_{ST}

| Bit Pattern | Word w | Position x_{ST} |
|---|---|---|
| B₀A₃B₁A₄B₂A₀B₃A₀ | W_{ST0} | 25 |
| A₃B₁A₄B₂A₀B₃A₀B₀ | W_{ST1} | 26 |
| B₁A₄B₂A₀B₃A₀B₀A₁ | W_{ST2} | 27 |
| A₄B₂A₀B₃A₀B₀A₁B | W_{ST3} | 28 |
| B₂A₀B₃A₀B₀A₁B₁A₂ | W_{ST4} | 29 |
| A₀B₃A₀B₀A₁B₁A₂B₂ | W_{ST5} | 30 |
| B₃A₀B₀A₁B₁A₂B₂A₃ | W_{ST6} | 31 |

Finally, for the above example, one code in the associated tables will also be given:

Code sequence A: 01111

Code sequence B: 0100

Angle coding 1 (length 40 bits):

0011101010011010101100101011100010111010

Angle coding 10 (32-bit excerpt V):

00111010100110101011001010111000

TABLE T_{A}
for code sequence A

| Bit Pattern | Word w | Partial Position x_{A} |
|---|---|---|
| 0111 | W_{A0} | 0 |
| 1111 | W_{A1} | 1 |
| 1110 | W_{A2} | 2 |
| 1101 | W_{A3} | 3 |
| 1011 | W_{A4} | 4 |

TABLE T_{B}
for code sequence B

| Bit Pattern | Word w | Partial Position x_{B} |
|---|---|---|
| 0100 | W_{B0} | 0 |
| 1000 | W_{B1} | 1 |
| 0001 | W_{B2} | 2 |
| 0010 | W_{B3} | 3 |

TABLE T_{STA}

| Bit Pattern | Word w | Partial Position x_{STA} |
|---|---|---|
| 1100 | W_{STA0} | 0 |
| 1001 | W_{STA1} | 1 |
| 0011 | W_{STA2} | 2 |

TABLE T_{ST}

| Bit Pattern | Word w | Position x_{ST} |
|---|---|---|
| 01110000 | W_{ST0} | 25 |
| 11100000 | W_{ST1} | 26 |
| 11000001 | W_{ST2} | 27 |
| 10000011 | W_{ST3} | 28 |
| 00000111 | W_{ST4} | 29 |
| 00001110 | W_{ST5} | 30 |
| 00011101 | W_{ST6} | 31 |

In the example, one can see that it is especially advantageous if one of the code sequence lengths (L_{A} or L_{B}) is already a power of two. In the second example above, the total length is M₂=32 and L_{B}=4. The advantage here is then that only one of the code sequences A or B (specifically only code sequence A) has to be “cut off”. In the other code sequence (in this case the code sequence B), all the code sequences as well as their cyclical continuations are kept complete in their entirety over 360°.

For the number of code elements within 360°, the following then applies:

M₂=2*(KGV(L_{A}, L_{B})−E*L_{A}),

which means that only one of the code sequences B within 360° is incomplete, but all the code sequences A are plotted completely and are cyclically continued, or

M₂=2*(KGV(L_{A}, L_{B})−E*L_{B}),

which means that only one of the code sequences A is incomplete, but all the code sequences A are plotted completely and are cyclically continued, and E is an integer>0.

In FIG. 7, a graph is shown for ascertaining the position POS from read-out bit patterns (words) w based on the example of the second angle coding 10. In the second and third columns, the words w1 and w2 ascertained from the words w of FIG. 2 are shown. The six further columns show the question of whether the words w1 or w2 have been found in the tables T_{A}, T_{B}, T_{STA}. A “1” defines “found”. The next column marked “RV” defines the algorithm R1, R2, R3 or R4 to be used. In the following three columns, the partial positions x_{A}, x_{B} and x_{STA} are given. The next column contains the value “n” calculated by the rules given in FIG. 6. The last column now contains the position POS calculated in accordance with the corresponding algorithms R1, R2, R3, and R4.

The decoder device 3, 30 is advantageously embodied as an ASIC, and the required tables T, that is, the value sets required, are each hard-wired in the production of the ASIC. Alternatively, the tables T or value sets could instead be stored in memory in read-only memories, such as EPROMs.

In the second angle measuring device, a mixed form of memories is especially advantageous; on the one hand, fast access to the memory data, that is, the value sets, is attained, and on the other, rapid adaptation to the intended use is made possible. This is attained on the one hand because the value set T_{A}, T_{B} for the code sequences A and B and their cyclical continuations is embodied in hard-wired form, and in addition, a memory that is also programmable after the mask production is provided, and the individually required value set T_{ST}, T_{STA} of the joint ST is stored in this programmable memory, in other words, in the tables T_{ST} and T_{STA}, respectively. The programmable memory is a read-only memory and is embodied for instance as an EPROM.

As shown schematically in FIG. 5, the absolute angle coding 10 in the example of FIG. 1 can be expanded with an incremental graduation 40. Once again within one angle sector of one code element, a whole number, advantageously greater than 1, of incremental graduation periods is disposed.

The invention can be especially advantageously used on the optical scanning principle, since an optically scannable angle coding 1, 10 with a maximum number of possible different positions over 360° (one revolution of the angle coding 1, 10) can be produced replicably, and thus especially high-resolution position measurement is made possible. The detector array 2, 20 and the decoder device 3, 30 can be accommodated jointly in an opto-ASIC.

However, the invention is not limited to the optical scanning principle, but can also be used with magnetic, inductive and capacitive scanning principles.

1-15. (canceled)

16. An absolute angle coding comprising:
a first code sequence disposed within 360°, wherein said first code sequence has a first length and is disposed N_{A} times in succession;
a second code sequence disposed within 360°, wherein said second code sequence has a second length and is disposed N_{B} times in succession, wherein said first code sequence and said second code sequence in combination absolutely unambiguously encode said 360°, wherein:
N_{A} is greater than or equal to 2;
N_{B} is greater than or equal to 2 and N_{A} is not equal to N_{B};
said first length is not equal to said second length; and
said first code sequence and said second code sequence are disposed in one common track, in that a part of said first code sequence and a part of said second code sequence are disposed in alternation.

17. The absolute angle coding as defined by claim 16, wherein said first length is not an integral multiple of said second length.

18. The absolute angle coding as defined by claim 17, wherein said first length differs by 1 from said second length.

19. The absolute angle coding as defined by claim 16, wherein N_{A} and N_{B} are integers.

20. The absolute angle coding as defined by claim 19, wherein one code element of said first code sequence and one code element of said second code sequence are disposed in alternation, and over 360°, a number M₁=2*KGV (L_{A}, L_{B}) code elements are disposed, where KGV (L_{A}, L_{B}) is the least common multiple of L_{A} and L_{B}, wherein L_{A} is said first length and L_{B} is the second length.

21. The absolute angle coding as defined by claim 20, wherein over 360°, a number M₁=2*L_{A}*L_{B} code elements are disposed.

22. The absolute angle coding as defined by claim 16, wherein one code element of said first code sequence and one code element of said second code sequence are disposed in alternation, and over 360°, a number M₂<2*KGV (L_{A}, L_{B}) code elements are disposed, where
KGV (L_{A}, L_{B}) is the least common multiple of L_{A} and L_{B}, wherein L_{A} is the first length and L_{B} is the second length.

23. The absolute angle coding as defined by claim 22, wherein over 360°, M₂=2^{k} code elements are disposed, where k is greater than 4 and is an integer.

24. The absolute angle coding as defined by claim 22, wherein over 360°, a number M₂=2*(KGV (L_{A}, L_{B})−E * L_{A}) is disposed, or
a number M₂=2*(KGV (L_{A}, L_{B})−E * L_{B}) is disposed,
where E is an integer>0.

25. The absolute angle coding as defined by claim 24, wherein over 360°, M₂=2^{k} code elements are disposed, where k is greater than 4 and is an integer.

26. An absolute angle measuring device, comprising:
an angle coding comprising:
a first code sequence disposed within 360°, wherein said first code sequence has a first length and is disposed N_{A} times in succession;
a second code sequence disposed within 360°, wherein said second code sequence has a second length and is disposed N_{B} times in succession, wherein said first code sequence and said second code sequence in combination absolutely unambiguously encode said 360°, wherein:
N_{A} is greater than or equal to 2;
N_{B} is greater than or equal to 2 and N_{A} is not equal to N_{B};
said first length is not equal to said second length; and
said first code sequence and said second code sequence are disposed in one common track, in that a part of said first code sequence and a part of said second code sequence are disposed in alternation; and
a detector array for scanning said first code sequence and said second code sequence and for generating code words; and
a decoding device for decoding said code words and for generating position values.

27. The absolute angle measuring device as defined by claim 26, wherein said first length is not an integral multiple of said second length.

28. The absolute angle measuring device as defined by claim 27, wherein said first length differs by 1 from said second length.

29. The absolute angle measuring device as defined by claim 26, wherein N_{A} and N_{B} are integers.

30. The absolute angle measuring device as defined by claim 29, wherein one code element of said first code sequence and one code element of said second code sequence are disposed in alternation, and over 360°, a number M₁=2*KGV (L_{A}, L_{B}) code elements are disposed, where
KGV (L_{A}, L_{B}) is the least common multiple of L_{A} and L_{B}, wherein L_{A} is said first length and L_{B} is the second length.

31. The absolute angle measuring device as defined by claim 30, wherein over 360°, a number M₁=2*L_{A}*L_{B} code elements are disposed.

32. The absolute angle measuring device as defined by claim 26, wherein one code element of said first code sequence and one code element of said second code sequence are disposed in alternation, and over 360°, a number M₂<2*KGV (L_{A}, L_{B}) code elements are disposed, where
KGV (L_{A}, L_{B}) is the least common multiple of L_{A} and L_{B}, wherein L_{A} is the first length and L_{B} is the second length.

33. The absolute angle measuring device as defined by claim 32, wherein over 360°, M₂=2^{k} code elements are disposed, where k is greater than 4 and is an integer.

34. The absolute angle measuring device as defined by claim 33, wherein over 360°, a number M₂=2*(KGV (L_{A}, L_{B})−E * L_{A}) is disposed, or
a number M₂=2*(KGV (L_{A}, L_{B})−E * L_{B}) is disposed,
where E is an integer>0.

35. The absolute angle measuring device as defined by claim 34, wherein over 360°, M₂=2^{k} code elements are disposed, where k is greater than 4 and is an integer.

36. The absolute angle measuring device as defined by claim 26, wherein said decoding device comprises a first value set for decoding a first succession of code words, which occurs each time upon scanning of one of said first code sequence and of its cyclical continuation; and
said decoding device comprises a second value set for decoding a second succession of code words, which occurs each time upon scanning of one of said second code sequence and of its cyclical continuation.

37. The absolute angle measuring device as defined by claim 36, wherein
wherein one code element of said first code sequence and one code element of said second code sequence are disposed in alternation, and over 360°, a number M₂<2*KGV (L_{A}, L_{B}) code elements are disposed, where
KGV (L_{A}, L_{B}) is the least common multiple of L_{A} and L_{B}, wherein L_{A} is the first length and L_{B} is the second length; and
said decoding device comprises:
a second value set for decoding a second succession of code words, which occurs each time upon scanning of one of said second code sequence and of its cyclical continuation; and
a third value set, which is suitable for decoding a joint of said first code sequence and/or of said second code sequence.

38. The absolute angle measuring device as defined by claim 37, wherein said third value set is stored in a programmable read-only memory, and said first value set and said second value set are in hard-wired form.

39. The absolute angle measuring device as defined by claim 26, further comprising an incremental track disposed concentrically to said absolute angle coding, and within one code element, a whole number of incremental graduation periods is disposed.

40. The absolute angle measuring device as defined by claim 40, wherein within one code element a whole number greater than 1 of incremental graduation periods is disposed.
